(19) United States
(12) Patent Application Publication
(10) Pub. No.: US 2006/0143401 A1
(43) Pub. Date: Jun. 29, 2006

(54) Method and apparatus for prefetching based on cache fill buffer hits

(76) Inventors: Jacob Doweck, Haifa (IL); Ehud Cohen, Kiryat Motskin (IL); Ziv Barukh, Nesher (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/023,838

(22) Filed: Dec. 27, 2004

(51) Int. Cl. G06F 13/00

(52) U.S. Cl. 711/137

(57) ABSTRACT

An apparatus and method for prefetching based on fill buffer hits is disclosed. In one embodiment, a processor includes a cache fill buffer and a prefetcher. The cache fill buffer has a number of fill buffer entry locations. Each load entry location is to store a load entry, including an address of data to be loaded into a cache. The prefetcher generates, in response to an instruction needing data from a first address, a request to prefetch data from a second address, if one of the cache fill buffer entries corresponds to the first address.

### BACKGROUND

1. Field

The present disclosure pertains to the field of data processing apparatuses and, more specifically, to the field of prefetching data in data processing apparatuses.

2. Description of Related Art

In typical data processing apparatuses, data needed to process an instruction may be stored in a memory. The latency of fetching the data from the memory may add to the time required to process the instruction, thereby decreasing performance. To improve performance, techniques for speculatively fetching data before it may be needed have been developed. Such prefetching techniques involve moving the data closer to the processor in the memory hierarchy, for example, moving data from main system memory to a cache, so that if it is needed to process an instruction, it will be take less time to fetch it.

However, the prefetching of data that is not needed to process an instruction is a waste of time and resources. Therefore, important considerations in the implementation of prefetching include a determination of what data to prefetch and when to prefetch it. For example, one approach is to use prefetch circuitry to identify and store the typical distance between the addresses of data needed for successive iterations of a particular instruction. Then, the decoding of that instruction is used as a trigger to prefetch data from the memory location that is that typical distance away from the address from which data is presently needed.

### BRIEF DESCRIPTION OF THE FIGURES

The present invention is illustrated by way of example and not limitation in the accompanying figures.

FIG. 1 illustrates an embodiment of a processor including circuitry for prefetching based on fill buffer hits.

FIG. 2 illustrates an embodiment of a system for using techniques for prefetching based on fill buffer hits.

FIG. 3 illustrates an embodiment of a method for prefetching based on fill buffer hits.

### DETAILED DESCRIPTION

The following description describes embodiments of techniques for prefetching based on cache fill buffer hits. In the following description, numerous specific details such as processor and system configurations, are set forth in order to provide a more thorough understanding of the present invention. It will be appreciated, however, by one skilled in the art that the invention may be practiced without such specific details. Additionally, some well known structures, circuits, and the like have not been shown in detail, to avoid unnecessarily obscuring the present invention.

Embodiments of the present invention provide techniques for prefetching data, where data may be any type of information, including instructions, represented in any form recognizable to the data processing apparatus in which the techniques are used. The data may be prefetched from any level in a memory hierarchy to any other level, for example, from a main system memory to a level one (“L1”) cache, and may be used in data processing apparatuses with any other levels of memory hierarchy, between, above, or below the levels from and to which the prefetching is performed. For example, in a data processing system with a main memory, a level two (“L2”) cache, and an L1 cache, the prefetching techniques may be used to prefetch data to the L1 cache from either the L2 cache or main memory, depending on where the data may be found at the time of the prefetch, and may by used in conjunction with any other hardware or software based techniques for prefetching to either the L1 or the L2 cache, or both.

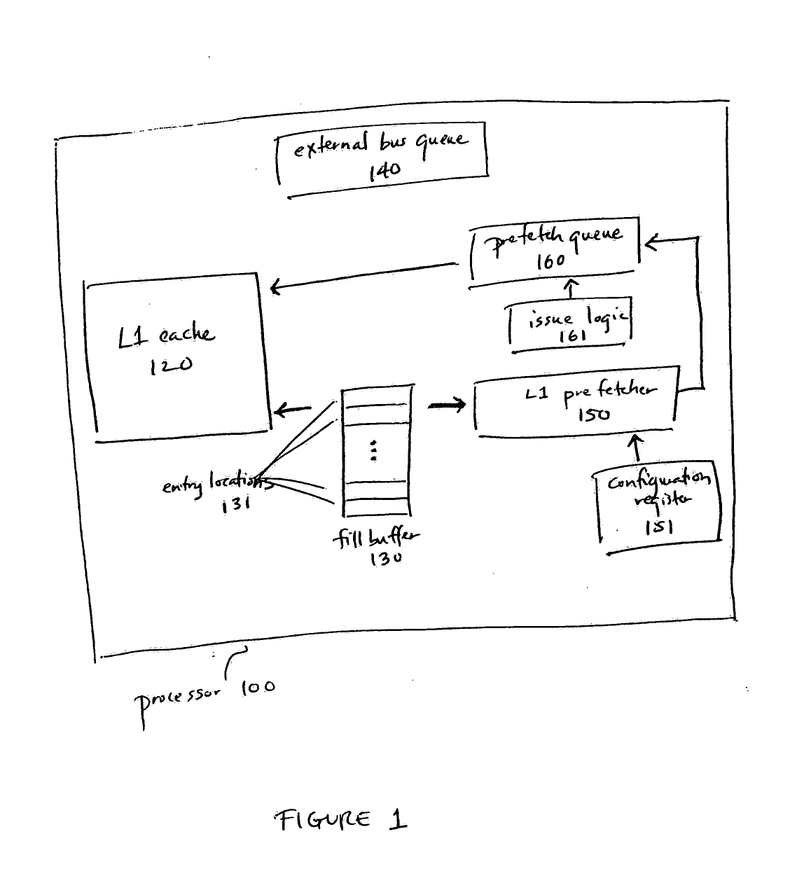

FIG. 1 illustrates an embodiment of a processor 100 including circuitry for prefetching based on cache fill buffer hits. The processor may be any of a variety of different types of processors that include a L1 cache and a cache fill buffer. For example, the processor may be a general purpose processor such as a processor in the Pentium® Processor Family, the Itanium® Processor Family, or other processor family from Intel Corporation, or another processor from another company.

In the embodiment of FIG. 1, processor 100 includes L1 cache 120, fill buffer 130, external bus queue 140, L1 prefetcher 150, configuration register 151, prefetch queue 160, and issue logic 161.

Instructions for execution by processor 100 may identify a memory address at which data needed by the instruction is stored. The data from the memory address may have been previously loaded from a memory accessible by processor 100 to L1 cache 120, in which case the instruction may be executed using the data from L1 cache 120. However, if the data is not presently stored in L1 cache 120, a request may be made to fetch the data and load it into L1 cache 120. Such a request will be referred to in this description as a “demand” request.

A demand request may be made by storing an entry in fill buffer 130. Fill buffer 130 includes a number of entry locations 131, where each entry location 131 may be used to store information related to a request to load a cache line worth of data into L1 cache 120, as well as the data itself after it is fetched but before it is loaded into L1 cache 120. The entries in fill buffer 130 are used to issue and track the transaction needed to fulfill the request. For example, the information stored in an entry location 131 may include the address of the data to be loaded.

Requests to load data into L1 cache 120 generated by the prefetch techniques of the present invention, or by any other prefetch techniques, may also be made by storing an entry in fill buffer 130. Therefore, an entry location 131 may include a place to store information to indicate whether the corresponding entry is a demand request or a prefetch request.

The fulfillment of a request to load data into L1 cache 120 may require a transaction involving a component connected to processor 100 by an external bus, for example, a transaction to read data from system memory. In that case, a cache load request may also be stored in external bus queue 140. External bus queue 140 is also used to store information regarding other transactions involving external components, until these transactions are issued, performed, or ready to be performed.

L1 prefetcher 150 is used in this embodiment to generate requests to prefetch data to be loaded into L1 cache 120. The determination of when to prefetch data is based on the contents of fill buffer 130. In this embodiment, a certain number of hits to an entry in fill buffer 130 triggers L1 prefetcher 150 to generate a prefetch request. For example, when processor 100 executes an instruction requiring data from an address that corresponds to an entry in fill buffer 130, L1 prefetcher 150 generates a prefetch request. Alternatively, L1 prefetcher 150 may be configured to generate a prefetch request the second, third, fourth, or Nth time that processor 100 executes instruction, whether the same or a different instruction, that requires data from a given address that corresponds to an entry in fill buffer 130. N may be any fixed or programmable number, and, if the latter, a value for N may be programmed into configuration register 151. In another embodiment, the determination that a fill buffer hit has occurred may be based on the decoding of instructions rather than the execution of instructions, or on any processing of instructions that involves the identification of data or the address of data that is needed by the instruction.

Also, the determination of what data to prefetch is based on the contents of fill buffer 130. In this embodiment, when a prefetch request is triggered by a hit to an entry in fill buffer 130, the address to be prefetched is greater than the address in the entry that was hit by the line size of L1 cache 120. For example, if the line size of L1 cache 120 is 64 bytes, and the address of the data to be loaded by the entry that was hit in fill buffer 130 is stored within a certain 64 byte portion of memory aligned to L1 cache 120, then L1 prefetcher 150 will generate a request to prefetch the data stored in the next consecutive 64 byte portion of memory.

Prefetch queue 160 is used to store prefetch requests generated by L1 prefetcher 150 until they are issued by prefetch issue logic 161. In this embodiment, prefetch queue 160 is a first-in first-out queue (“FIFO”), but may be any type of queue within the scope of the present invention. Also in this embodiment, if prefetch queue 160 is full when a new request is generated, the oldest request in prefetch queue 160 is dropped to make room for the new request. Alternatively, if prefetch queue 160 is full when a new request is generated, the new request may be dropped, and the old requests are held in the prefetch queue until issued.

Prefetch issue logic 161 issues prefetch requests from prefetch queue 160 based on a combination of conditions. In other embodiments of the invention, prefetch issue logic 161 may issue prefetch requests based on any other combination of the same or other conditions, including any single criteria by itself. The conditions, and values of parameters determining whether the conditions are met, may be selected with a goal of reducing the potential negative side effects of prefetching, such as the overloading of resources, cache pollution, and thrashing. The conditions and the parameter values may be configurable so that their impact may be measured in a real system. In this embodiment, each of the following five conditions must be met.

The first condition is that the L1 cache port to which prefetch requests are issued is idle. For example, L1 cache 120 may have a load port and a store port, and prefetch requests may be sent to the store port because it is more likely to be idle than the load port. In that case, the first condition is that the store port of L1 cache 120 is idle.

The second condition is that at least a certain number L of the entry locations 131 in fill buffer 130 are empty. The third condition is that no more than a certain number P of the entry locations 131 in fill buffer 130 are allocated to prefetch requests. The fourth condition is that there are at least X entries empty in external bus queue 140. The values of the parameters L, P, and X may be fixed or programmable, and, if the latter, may be programmed into configuration register 151. For example, the value of L may be 2, the value of P may be 3, and the value of X may be 1. These three conditions and the choice of the corresponding parameter values may be used to control bus traffic and prevent overloading of resources, by constraining the number of cache load requests and balancing the number of prefetch requests against the number of outstanding demand requests.

The fifth condition is that L1 cache 120 is able to accept a prefetch request. For example, L1 cache 120 may not be able to accept a prefetch request if an atomic sequence of operations involving L1 cache 120 is in progress.

If all of the conditions for issuing a prefetch request from prefetch queue 160 are met, a cache lookup is performed to see if cache 120 or fill buffer 130 already contains the requested line, which may occur, for example, if the data has been loaded between the time that the prefetch request is generated and the time that it is issued, or if the data was already present at the time the prefetch request was generated. If the cache lookup finds the requested line, then the prefetch request is dropped. Otherwise, the prefetch request is performed in the same manner that a demand request would be performed.

When the line of data to fulfill the prefetch request arrives, the line may be loaded into L1 cache 120 or dropped, depending on a configuration parameter that may be fixed or programmed in configuration register 151. If the configuration parameter is set to drop, then the line may be dropped instead of loaded into L1 cache 120. However, if the prefetched line is hit by a demand request before being dropped, for example while stored in load buffer 130, the line may be loaded into L1 cache 120 even when the configuration parameter is set to drop. If the configuration parameter is set to drop and the prefetched line is dropped, the prefetch request may improve performance by having moved the requested data closer to processor 100, for example, from a main memory to an L2 cache.

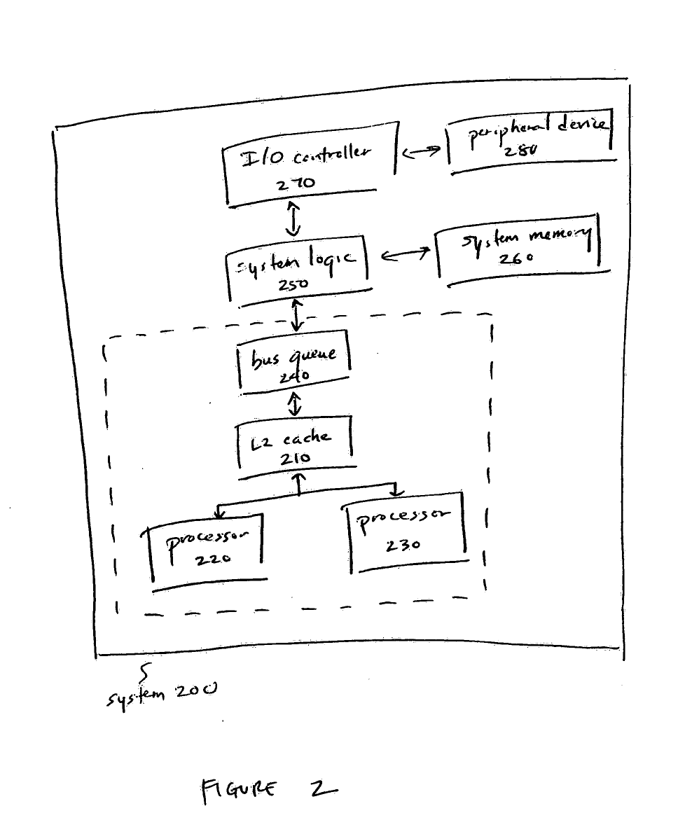

FIG. 2 illustrates an embodiment of techniques for prefetching based on cache fill buffer hits in system 200, which includes L2 cache unit 210. System 200 also includes a first processor 220 and a second processor 230, each including circuitry for prefetching to an L1 cache according to the embodiment of FIG. 1. L2 cache unit 210 and processors 220 and 230 may be included on the same silicon chip, on separate silicon chips within the same package, or in separate packages. In the former cases, the chip or package may also include other components, such as additional processors with or without their own L1 caches and L1 prefetch circuitry.

L2 cache unit 210 may include an L2 cache and circuitry for loading data into the L2 cache, such as circuitry for prefetching and/or streaming data into the L2 cache, or such circuitry may be included in a unit or component outside of L2 cache unit 210. An L2 prefetcher may treat an L1 prefetch request that is issued according to an embodiment of the invention the same as it treats an L1 demand request, so the techniques of the present invention may improve performance by triggering an L2 prefetch before a demand request that would trigger the same L2 prefetch is made.

System 200 also includes external bus queue 240, which may be used instead of an external bus queue 140, as shown in FIG. 1, in each of processors 220 and 230. In this case, the fourth condition for issuing a prefetch request, and the parameter X, as described above, may refer to external bus queue 240 instead of external bus queue 140. This fourth condition and the choice of the corresponding parameter X may be used to give priority to demand requests of one of the processors over prefetch requests of the other processor, in contrast to the second and third conditions, which may be used to give priority to demand requests of one of the processors over its own prefetch requests.

System 200 also includes system logic 250, system memory 260, input/output (“I/O”) controller 270, and peripheral device 280. System logic 250 may be used to control transactions involving system memory 260. System memory 260 may be any type of memory, such as dynamic or static read access memory, read only memory, or programmable read only memory. I/O controller 270 may be used to control transactions involving peripheral device 280. Peripheral device 280 may be any type of peripheral device, such as a keyboard, mouse, printer, modem, or data storage device, such as an optical or magnetic disk. System 200 may also include any number of other devices or components, such as display devices or additional processors, memory, or peripheral devices that are not shown.

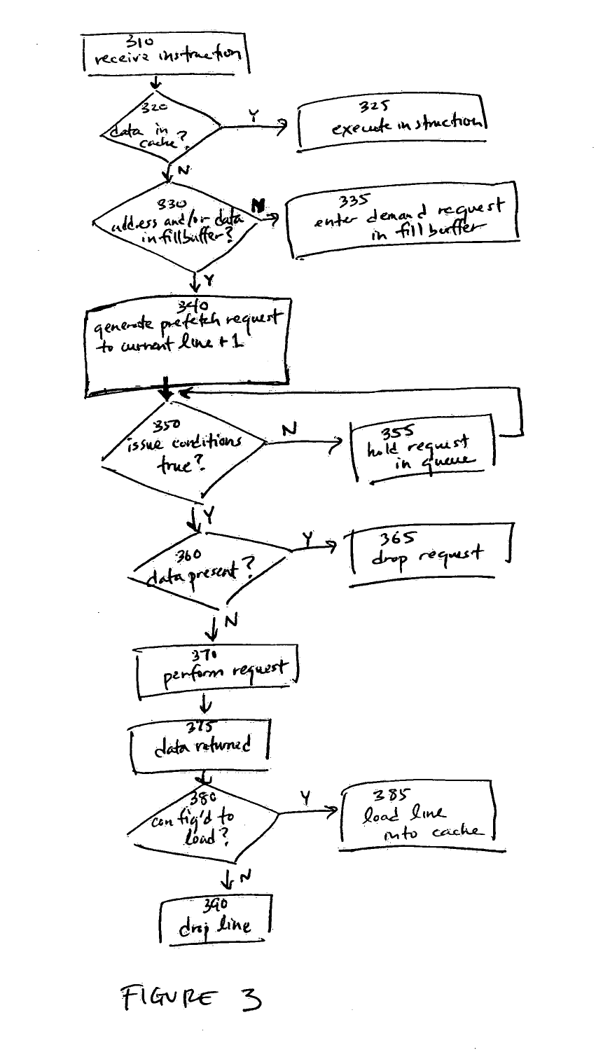

FIG. 3 is a flowchart illustrating an embodiment of a method for prefetching based on cache fill buffer hits. In block 310, an instruction is received that requires data. The instruction may identify an address at which the data is stored in memory, but the data may have been previously loaded into an L1 cache, or a request to load the data may have been entered into an L1 fill buffer. Therefore, in block 320, the L1 cache is checked to see if the required data is present in the L1 cache. If it is present, then the instruction is executed in block 325. If it is not present, then, in block 330, which may be performed in parallel with block 320, the L1 fill buffer is checked for an outstanding entry to load the data from memory or an L2 cache. If there is no such outstanding entry, then, in block 335, a demand request is entered into the fill buffer. If there is such an outstanding entry, then, in block 340, a request to prefetch data from the next sequential cache line address is generated and placed in a prefetch queue.

In block 350, conditions are checked for issuing the request from the prefetch queue. The conditions may be the same as, or different from, the conditions described above with respect to the embodiment of FIG. 1. If the conditions are not true, then, in block 355, the prefetch request is held in the prefetch queue until the conditions are true or the request is overwritten by another request. If the conditions are true, then, in block 360, a cache lookup is performed to see if the requested data is already stored in the cache or fill buffer. If it is, then, in block 365, the prefetch request is dropped. If it is not, then in block 370, the prefetch request is performed. In either case, to prevent a chain reaction of prefetch requests, a fill buffer hit in block 360 does not generate a new prefetch request.

In block 375, a cache line containing the prefetched data is returned. In block 380, a configuration parameter is checked to determine if the line should be loaded into the cache. If the configuration parameter is set to load the line, then, in block 385, the line is loaded into the cache. If, instead, the configuration parameter is set to drop the line, then, in block 390, the line is dropped, unless the line has been hit by a demand request, in which case it is loaded into the cache.

Processor 100, or any other processor or component designed according to an embodiment of the present invention, may be designed in various stages, from creation to simulation to fabrication. Data representing a design may represent the design in a number of manners. First, as is useful in simulations, the hardware may be represented using a hardware description language or another functional description language. Additionally or alternatively, a circuit level model with logic and/or transistor gates may be produced at some stages of the design process. Furthermore, most designs, at some stage, reach a level where they may be modeled with data representing the physical placement of various devices. In the case where conventional semiconductor fabrication techniques are used, the data representing the device placement model may be the data specifying the presence or absence of various features on different mask layers for masks used to produce an integrated circuit.

In any representation of the design, the data may be stored in any form of a machine-readable medium. An optical or electrical wave modulated or otherwise generated to transmit such information, a memory, or a magnetic or optical storage medium, such as a disc, may be the machine-readable medium. Any of these mediums may “carry” or “indicate” the design, or other information used in an embodiment of the present invention, such as the instructions in an error recovery routine. When an electrical carrier wave indicating or carrying the information is transmitted, to the extent that copying, buffering, or re-transmission of the electrical signal is performed, a new copy is made. Thus, the actions of a communication provider or a network provider may be making copies of an article, e.g., a carrier wave, embodying techniques of the present invention.

Thus, techniques for prefetching based on cache fill buffer hits are disclosed. While certain embodiments have been described, and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor comprising:
a cache fill buffer having a plurality of fill buffer entry locations; and
a prefetcher to generate, in response to an instruction needing data from a first address, a request to prefetch data from a second address if the cache fill buffer includes an entry in one of the plurality of fill buffer entry locations corresponding to the first address.

2. The processor of claim 1, wherein the second address is greater than the first address by the line size of a cache to be filled by the cache fill buffer.

3. The processor of claim 1, further comprising a prefetch queue to store the second address until the request is issued.

4. The processor of claim 3, further comprising logic to determine if a condition for issuing prefetch requests is met, and to issue the request if the condition is met.

5. The processor of claim 3, further comprising logic to issue the request if at least one of the plurality of fill buffer entry locations is empty.

6. The processor of claim 3, further comprising logic to issue the request if no more than P of the plurality of fill buffer entry locations are filled with a prefetch request, where P is less than the number of fill buffer entry locations.

7. The processor of claim 3, further comprising:
a register to store a configuration parameter L; and
logic to issue the request if at least L of the plurality of fill buffer entry locations is empty.

8. The processor of claim 3, further comprising:
a register to store a configuration parameter P; and
logic to issue the request if no more than P of the plurality of fill buffer entry locations is filled with a prefetch request.

9. The processor of claim 3, further comprising logic to issue the request to a cache port if the cache port is idle.

10. The processor of claim 3, wherein the cache has a plurality of ports, further comprising logic to issue the request to one of the plurality of ports if the one of the plurality of ports is idle.

11. The processor of claim 10, wherein the one of the plurality of ports is a store port.

12. The processor of claim 3, wherein the prefetch queue is a first-in-first-out prefetch queue.

13. The processor of claim 3, further comprising:
an external bus queue having a plurality of bus queue entry locations;
a register to store a configuration parameter X; and
logic to issue the request if at least X of the plurality of bus queue entry locations is empty.

14. The processor of claim 1, further comprising a configuration parameter to indicate whether the prefetched data is to be loaded into a cache to be filled by the cache fill buffer.

15. A processor comprising:
a cache fill buffer having a plurality of fill buffer entry locations;
a register to store a configuration parameter N; and
a prefetcher to generate, in response to an Nth instruction needing data from a first address, a request to prefetch data from a second address if the cache fill buffer includes an entry in one of the plurality of fill buffer entry locations corresponding to the first address.

16. A system comprising:
a dynamic random access memory;
a level two cache coupled to the dynamic random access memory;
a first processor coupled to the level two cache, including:
a first cache fill buffer having a first plurality of fill buffer entry locations to fill a first level one cache; and
a first prefetcher to generate, in response to the first processor needing data from a first address, a first request to prefetch data from a second address if the first cache fill buffer includes an entry in one of the first plurality of fill buffer entry locations corresponding to the first address; and
a second processor coupled to the level two cache, including:
a second cache fill buffer having a second plurality of fill buffer entry locations to fill a second level one cache; and
a second prefetcher to generate, in response to the second processor needing data from a third address, a second request to prefetch data from a fourth address if the second cache fill buffer includes an entry in one of the second plurality of fill buffer entry locations corresponding to the third address.

17. The system of claim 16, wherein:
the first processor also includes a first prefetch queue to store the second address until the first request is issued; and
the second processor also includes a second prefetch queue to store the fourth address until the second request is issued.

18. The system of claim 17, wherein the level two cache, the first processor, and the second processor are all on a single silicon chip.

19. The system of claim 18, wherein:
the single chip further comprises:
an external bus queue having a plurality of bus queue entry locations; and
the first processor also includes:
a first register to store a first configuration parameter X1; and
first logic to issue the first request if at least X1 of the plurality of bus queue entry locations is empty; and
the second processor also includes:
a second register to store a second configuration parameter X2; and
second logic to issue the second request if at least X2 of the plurality of bus queue entry locations is empty.

20. A method comprising:
receiving an instruction needing data from a first address; and
generating a request to prefetch data from a second address if an entry corresponding to the first address is stored in a cache fill buffer.

21. The method of claim 20, wherein the second address is greater than the first address by the line size of a cache to be filled from the cache fill buffer.

22. The method of claim 20, further comprising:
storing the request in a prefetch queue until the request is issued;
determining if a condition for issuing prefetch requests is met; and
issuing the request if the condition is met.

23. The method of claim 22, wherein determining if the condition is met includes at least one of determining whether a cache port is idle, determining the number of empty entries in the cache fill buffer, determining the number of cache fill buffer entries allocated to prefetch requests, determining the number of empty entries in an external bus queue, and determining whether the cache to be filled by the cache fill buffer is able to accept the request.
